(19) United States
(12) Patent Application Publication
(10) Pub. No.: US 2005/0094547 A1
(43) Pub. Date: May 5, 2005

(54) Master disk exposure apparatus and master disk exposure method

(75) Inventors: Toshinori Sugiyama, Tsukuba-shi (JP); Terufumi Yoshioka, Moriya-shi (JP); Yuzuru Chika, Tsukuba-shi (JP); Katsunori Miyata, Yuki-gun (JP)

Correspondence Address: OLIFF & BERRIDGE, PLC, P.O. BOX 19928, ALEXANDRIA, VA, 22320, US

(73) Assignee: HITACHI MAXELL, LTD., Ibaraki-shi (JP)

(21) Appl. No.: 10/970,003

(22) Filed: Oct. 22, 2004

(30) Foreign Application Priority Data
Oct. 29, 2003 (JP) 2003-369195

(51) Int. Cl. G11B 7/24

(52) U.S. Cl. 369/275.4

(57) ABSTRACT

In Two-dimensional optical Compensation Exposure method, Beam 1, which has an intensity not less than a sensitivity of a photoresist layer and has a predetermined irradiation timing of exposed patterns, is radiated onto a predetermined area of the photoresist, and Beam 2, which has an intensity less than the sensitivity of the photoresist layer and has an irradiation timing of exposed patterns opposite to the predetermined timing, is radiated onto an area different from the predetermined area. Beam 2, which has the intensity less than the sensitivity of the photoresist layer, is radiated onto both sides P/P (2 T) in a disk radial direction of an area in which a shortest mark P₂₂ is formed. The pit width is uniform irrelevant to the pit length. Further, it is possible to form the pit having a width shorter than a pit length. Therefore, it is possible to realize a high density.

### BACKGROUND OF THE INVENTION

1. Field of the Invention

The present invention relates to a master disk exposure apparatus and a master disk exposure method, so called “Two-Dimensional Optical Compensation Exposure (TOCE)”. In particular, the present invention relates to a master disk exposure apparatus and a master disk exposure method which are preferably usable to produce a high recording density information-recording medium. The present invention also relates to a stamper for replicating an information-recording medium and a substrate for an information-recording medium produced by using the same.

2. Description of the Related Art

In the technical field of the information-recording medium, the improvement in the recording density is a more important technical task. It has been hitherto intended to overcome such a technical task from both viewpoints, i.e., the improvement in the linear recording density to be achieved along the information track and the improvement in the surface recording density to be achieved by narrowing the track pitch.

The substrate for the information-recording medium, which is used for the information-recording medium such as optical disks, is produced by the injection molding by using a template of a stamper formed with a predetermined pattern. The stamper is replicated from a master disk which is formed by using a master disk exposure apparatus. In such a master disk exposure apparatus, a laser beam having a constant intensity, which is emitted from a laser light source, is intensity-modulated or modulated for its intensity to have a pulse form by using an optical modulator. The laser beam, which has been intensity-modulated to have the pulse form, is collected by an objective lens onto a photoresist layer of the master disk. As shown in FIG. 20, the intensity distribution of the laser, which is obtained in a laser spot 101 radiated onto the photoresist layer, is a Gaussian distribution in which the intensity is highest at the central portion of the laser spot 101, and the intensity is gradually lowered at circumferential portions. The sensitivity L of the photoresist layer is set to have a predetermined value which is smaller than the maximum value Lₘₐₓ of the laser intensity in the laser spot 101. Therefore, a low exposure portion 103, which is exposed with the laser beam having an intensity (power) lower than the sensitivity L of the photoresist layer, appears around a pit 102 having been subjected to the cutting. The sensitivity L of the photoresist layer herein refers to such an exposure intensity that the layer thickness of the photoresist layer is 0.9H after carrying out the development process provided that H represents the layer thickness of the photoresist layer of the unexposed portion after carrying out the development process.

When the pulse width of the exposure signal is progressively narrowed in order to improve the linear recording density, the following problem arises. As shown in FIG. 21, low exposure portions 103, 103′, which are formed at surrounding portions of pits 102, 103′, are overlapped with each other at a portion (space) between the pit 102 and the adjacent pit 102′ at a stage at which the pulse width of the exposure signal for forming the pit 102 is smaller than the diameter of the laser spot 101 collected on the photoresist layer. The phenomenon, in which the low exposure portions are overlapped with each other, is called “overlap”. In FIG. 21, the X direction indicates the track direction. The exposure intensity of the exposure light applied to the photoresist is the multiplied value which is obtained by multiplying the intensity of the laser beam radiated onto the photoresist layer and the radiation time of the laser spot. Therefore, as shown in an upper part of FIG. 21, the position which corresponds to the sensitivity L of the photoresist layer to be obtained when no overlap arises, i.e., the position X₀ at which the pit edge of the pit 102 is formed by the development is shifted to the position X₁ due to the occurrence of the overlap. As for the adjacent pit 102′, the pit edge is shifted to approach the pit 102 in the track direction in the same manner as described above. As a result, the distance of the space formed between the pit 102 and the pit 102′ is consequently shortened. Therefore, when the overlap arises between the low exposure portions 103, 103′, it is difficult to strictly control the exposure intensity on the photoresist layer at the portion for forming the pit and the exposure intensity on the photoresist layer at the portion for forming the space. As a result, when an information-recording medium is manufactured after performing the step of developing the photoresist layer, the step of transferring the pit pattern to the substrate, and the step of forming the thin films on the substrate, then the pit length is increased, the space length is decreased, the pit edge position is shifted in the track direction, and the jitter of the reproduced signal is increased. On the other hand, the overlap is not caused by the low exposure portions in an area in which no pit is formed at an adjacent position. Therefore, the pit edge position is the position (position X₀) which is determined by the sensitivity L of the photoresist as shown in FIG. 21. That is, the pit edge position is varied or not varied from the designed value depending on the situation around the pit (presence or absence of the pit). Even when pits having an identical length are formed, the lengths of the pits are dispersed. This also causes the increase in the jitter.

In order to mitigate the influence of the “overlap” as described above, for example, the following countermeasures have been adopted for the improvement. That is, the so-called “cutting” or “cutout” is applied to the exposure signal taking the diameter of the laser spot 101 into consideration. Alternatively, in order to dissolve the insufficient exposure caused at the front end and the rear end of the pit 102 and the excessive exposure caused at the waist portion of the pit 102, the ratio between the laser intensity for the intermediate portion and the laser intensity for the rising and falling is adjusted especially in relation to the exposure signal having a long signal length. For example, as shown in FIGS. 22A and 22B, when the bit data composed of the random waveform, in which the shortest was 2T and the longest was 8T with the (1, 7) RLL waveform, was subjected to the cutting on a master disk for an optical disk, the waveform of the exposure signal was adjusted as shown in FIG. 22C. The condition for the master disk cutting was as follows. In order to realize a recording capacity of 27 GB for the optical disk having the CD size, the length of T was 69.5 nm, the pulse width L1 at the front end and the rear end of the exposure waveform was L1=0.6T, the cutting L3 was L3=T−L1, the waist length L2 of the marks of not less than 3 T was L2=(n−2)T, and the relationship between the laser intensity P1 at the front end and the rear end and the laser intensity P2 at the waist portion was P2=P1×(L1/T). In the expression for L2, n indicates the mark length. For example, in the case of the 8T mark, n=8 is given. An i-line resist produced by TOKYO OHKA KOGYO CO., LTD. was applied to the master disk for the optical disk to have a thickness of 75 nm. In the master disk exposure apparatus, the wavelength of the laser beam was 257 nm, and the objective lens having a numerical aperture of 0.9 was used. The surface shape of the pit, which was obtained after performing the development process for the master disk for the optical disk, was observed by using AFM (atomic force microscope).

However, the following problem has arisen. That is, even when the recording strategy, in which the exposure signal pattern is adjusted as shown in FIGS. 22A and 22B, is used, the pit lengths of the obtained pits are greatly dispersed. FIG. 18 shows the distribution of the pit width and the length obtained by forming the pits of 2T to 8T by using the recording strategy as shown in FIGS. 22A and 22B, and then observing the lengths and the widths thereof by using AFM. According to this result, it is understood that the length is dispersed for the pit having any length, and the dispersion is conspicuous especially in the case of 2T. Therefore, in this example, the standard deviation a of the pit length dispersion is deteriorated to σ=10%.

Further, in addition to the problem of the overlap caused when the linear recording density is intended to be improved as described above, the problem of the overlap also arises when it is intended to improve the surface recording density by narrowing the track pitch. When the track pitch is smaller than the diameter of the laser spot collected on the photoresist layer, then the laser spots, which are used to perform the cutting for the pits on the adjacent tracks, are overlapped with each other at the land portion to be formed on the photoresist layer, and the overlap is caused at the low exposure portion. As a result, it is difficult to strictly control the exposure intensity for the photoresist layer at the portion for forming the pit and the exposure intensity for the photoresist layer at the portion for forming the land. The pit width is increased, the land width is decreased, and the signal crosstalk tends to occur between the adjacent tracks.

In order to dissolve the inconvenience as described above, the applicant disclosed in Japanese Patent Application Laid-open No. 2001-148139 an optical information-recording apparatus comprising a disk-rotating section which drives and rotates a master disk for an optical disk, an optical head which is arranged opposingly to the master disk or an information-recording surface of an optical information-recording medium and which radiates, onto the information-recording surface, an energy beam (laser beam) subjected to intensity modulation to have a pulse form with a correction signal, a carriage which transports the optical head in a radial direction of the master disk or the optical information-recording medium, a formatter which outputs an information signal, a cutting clock-generating section, and a signal-correcting section which generates the correction signal to be supplied to the optical head in accordance with the information signal supplied from the formatter, wherein an information signal to be recorded on a preceding adjacent track, an information signal to be recorded on a track intended to be subjected to recording, and an information signal to be recorded on a succeeding adjacent track are stored in first to third memories in a divided manner, a logical product is estimated for the information signals stored in the respective memories by using a logical circuit when information is recorded on the track intended to be subjected to the recording, and a level and/or a pulse length is corrected with a signal-correcting circuit for any information signal overlapped with the information signal to be recorded on the preceding adjacent track and/or the information signal to be recorded on the succeeding adjacent track.

When the information signal to be recorded on the preceding adjacent track, the information signal to be recorded on the track intended to be subjected to the recording, and the information signal to be recorded on the succeeding adjacent track are incorporated into the first to third memories to estimate the logical product of the information signals stored in the respective memories by using the logical circuit, it is possible to detect the overlap state of the information signals to be recorded on the respective tracks in relation to the radial direction of the master disk or the optical information-recording medium. Therefore, the mark (pit), which corresponds to the identical information signal, can be recorded on the master disk for the optical disk by correcting the level and/or the pulse length of the overlapped information signal by using the signal-correcting circuit irrelevant to the overlap state of the information signals (overlap state of the laser beams).

However, in the optical information-recording apparatus disclosed in Japanese Patent Application Laid-open No. 2001-148139, the information signal, which is stored in the formatter, is corrected with reference to the information signals to be recorded on the precedent or subsequent adjacent tracks for each of the information signals. Therefore, a problem arises such that the signal-correcting circuit constructed in a complicated manner is required. In particular, in the case of the exposure apparatus for cutting the master disk for the optical disk based on the CLV format adopted, for example, for DVD-ROM, the number of channel bits is changed for every track per one revolution of the master disk for the optical disk. Therefore, it is necessary to use a signal-correcting circuit constructed in a further complicated manner. In the case of the exposure apparatus for cutting the master disk for the optical disk based on the CLV format, it is difficult to correctly predict the information signal for the adjacent track to be exposed after one round, due to the error of the CLV circuit provided for this apparatus. Therefore, it is practically difficult to perform the cutting for the master disk for the optical disk on which no signal crosstalk is caused between the adjacent tracks.

### SUMMARY OF THE INVENTION

The present invention has been made in order to solve the problems involved in the conventional technique as described above, an object of which is to provide a master disk exposure method and a master disk exposure apparatus preferably usable to produce a high recording density optical information-recording medium wherein the deterioration of the jitter, which is caused by the overlap at the low exposure portion during master disk exposure, is avoided without using any complicated circuit structure. Another object of the present invention is to provide a substrate for an information-recording medium and a stamper preferably usable to produce a high density recording information-recording medium by using the master disk exposure apparatus and the master disk exposure method as described above.

According to a first aspect of the present invention, there is provided a master disk exposure method for exposing with a certain pattern a master disk which is used for making a disk-shaped information-recording medium and on which a photoresist layer is formed, the master disk exposure method comprising:
irradiating a predetermined area of a photoresist with a first laser beam which has an intensity not less than a sensitivity of the photoresist layer and which has a predetermined phase; and
irradiating an area of the photoresist different from the predetermined area with a second laser beam which has an intensity less than the sensitivity of the photoresist layer and which has a phase opposite to the predetermined phase.

In the present invention, the photoresist is exposed with the first laser beam having the intensity not less than the sensitivity of the photoresist layer (hereinafter appropriately referred to as “high intensity laser beam”) and with the second laser beam having the intensity less than the sensitivity of the photoresist layer (hereinafter appropriately referred to as “low intensity laser beam”). The high intensity laser beam is used to perform the exposure for the pattern formed with marks (pits). The low intensity laser beam is used to perform the auxiliary exposure (or the dummy exposure) in order to produce the same condition as that of the overlap described above although no development pattern is basically generated on the photoresist. In order to generate the development pattern on the photoresist, it is necessary to radiate an exposure light beam which is not less than the sensitivity (L) of the photoresist. The sensitivity of the photoresist layer is represented by the intensity of the exposure light beam at which the layer thickness of the photoresist layer is 0.9H after carrying out the development process provided that H represents the layer thickness of the photoresist layer at the non-exposed portion after carrying out the development process.

The low intensity laser beam has the phase opposite to that of the high intensity laser beam. Therefore, when the high intensity laser beam is radiated, the low intensity laser beam is not radiated basically. In this specification, the term “phase” of the laser beam means ON/OFF timing for radiating the laser beam as shown in FIGS. 3C and 3D. In this specification, the term “opposite phase” refers to not only the case in which a waveform of one laser beam is completely opposite or symmetrical to that of the other laser beam but also the case in which the waveform of said one laser beam has any ON signal for radiating the laser beam on the basis of the bit data while the waveform of the other laser beam is any waveform not to radiate the laser beam. For example, as shown in FIGS. 3B to 3D, Beam 2 is turned OFF when Beam 1 is turned ON while Beam 2 is turned ON when Beam 1 is turned OFF in accordance with the bit data. The waveform, which is used when the beam is turned ON, may have various shapes.

As shown in FIG. 20, the high intensity laser beam forms the low exposure portion 103 at the outside of the pit formation area 102. Therefore, when the pit formation areas are disposed adjacently in the track direction or in the direction perpendicular thereto (radial direction of the disk), the overlap appears as shown in FIG. 21. The exposure energy, which is applied to the overlap area, is in an amount larger than that of the designed value. FIG. 19A shows situations of deformation of the pit pattern caused by the overlap. On the right side in FIG. 19A, the light intensity distribution is schematically shown, which is given on a straight line X-X that traverses the pit formation areas P₂₁ and P₃₂ depicted in a plan view of the pit pattern on the left side. The pit formation areas P₂₁ and P₃₂ are disposed adjacently to one another in the direction perpendicular to the track. Therefore, the lower slopes of the light intensity distribution curves are overlapped with each other to receive the light having the light intensity as indicated by a hatched area on the right side of FIG. 19A. Therefore, the portions, in which the sensitivity L of the resist is exceeded, approach the center of the pit formation areas P₂₁ and P₃₂, and the pit formation areas P₂₁ and P₃₂ are deformed as depicted by broken lines on the left side of FIG. 19A. That is, the shape of the pit formation area is changed due to the presence of another pit formation area around the concerning pit formation area.

On the other hand, in the master disk exposure method of the present invention, when the high intensity laser beam is not radiated, the low intensity laser beam is radiated. The beams are radiated so that they are opposite to be ON and OFF or OFF and ON. For example, as indicated by areas LP₂₁, and RP₂₁ in FIG. 19B, two beams of the low intensity laser beams are radiated onto the both sides in the disk radial direction with respect to the radiation position of the high intensity laser beam for forming the pit formation area P₂₁, especially onto the positions which are separated from each other by a spacing distance d that is approximately equivalent to the track pitch p. The intensity of the low intensity laser beam is less than ½ of the sensitivity of the resist. FIG. 19B schematically shows, on the right side, the light intensity distribution given on a straight line Y-Y which traverses the pit formation area P₃₂ and the low intensity laser beam radiation area RP₂₂ depicted in a plan view of the pit pattern on the left side. Beam 1, which radiates the pit formation area P₃₂, is overlapped with Beam 2 which radiates the low intensity laser beam radiation area RP₂₂. Therefore, as indicated by a hatched area on the right side of FIG. 19B, the portion, in which the sensitivity L of the resist is exceeded, is shifted toward the low intensity laser beam radiation area RP₂₂. Similarly, the low intensity laser beam radiation areas LP₂₁, RP₂₁, LP₂₂, RP₂₂ also exist around the pit formation areas P₂₁, P₃₁, P₃₂. Therefore, the exposure intensity is uniformly increased at outer circumferential portions of any one of the pit formation areas P₂₁, P₃₁, P₃₂. A phenomenon, which resembles the overlap, also arises in the place in which no overlap occurs between the pit formation areas. Therefore, the surroundings of the pit formation areas P₂₁, P₃₁, P₃₂ are uniformly widened to the outside as indicated by broken lines at the surroundings of the pit formation areas P₂₁, P₃₁, P₃₂ shown in FIG. 19B. As a result, the sizes of the marks and the pits formed by the development are determined irrelevant to the presence or absence of the adjacent pit in the track direction or in the direction perpendicular thereto. Therefore, even when the track pitch is narrowed, it is possible to suppress the variation or fluctuation of the pit size and the pit shape. Thus, it is possible to reduce the jitter and the crosstalk of the high recording density information-recording medium. The master disk exposure method of the present invention dissolves the nonuniformity of the photoresist development caused by the overlap, and is so called “Two-Dimensional Optical Compensation Exposure (TOCE)” in the photoresist exposure. In the area LP₂₂, the low intensity laser beams, which are radiated for the tracks t₁, t₂, are overlapped with each other. However, as described above, the intensity of the low intensity laser beam is less than ½ of the sensitivity of the resist. Therefore, no pit is formed in the area LP₂₂ as a result of the development process. When the present invention is applied to a master disk exposure apparatus based on the CLV system, it is also unnecessary to correctly predict the exposure signal for the adjacent track to be exposed after one round. Therefore, it is unnecessary to provide any complicated signal-correcting circuit. The master disk exposure apparatus can be simply constructed, and it is possible to perform the correct pit array cutting.

The Two-dimensional Optical Compensation Exposure method according to the present invention may further comprise irradiating both sides in a disk radial direction of an area on which a shortest mark of the certain pattern is formed, with a third laser beam which has a laser intensity less than the sensitivity of the photoresist layer. According to an experiment performed by the inventors, the following fact has been found out. That is, even when it is intended to dissolve the problem caused by the overlap by using the recording strategy having the waist and the cutting as shown in FIG. 22, then the width of the shortest mark is conspicuously shorter than those of the marks having other lengths as shown in FIG. 21, and the variation amounts of the length and the width of the shortest mark are increased, which principally causes the increase in the jitter. The inventors have succeeded in solving the problem described above by using such a recording strategy that the third laser beam, which has the laser intensity less than the sensitivity of the photoresist layer, is radiated onto the both sides in the disk radial direction of the area in which the shortest mark is formed. That is, when the shortest mark is subjected to the exposure, the first laser beam and the third laser beam are simultaneously radiated (the first laser beam and the third laser beam have the identical phase in relation to the shortest mark). In order that the adjustment of the intensity modulation is simplified and the occurrence of the crosstalk, which would be otherwise caused by any excessive increase in the width of the shortest mark, is avoided, the intensity of the third laser beam may be approximately the same as the intensity of the second laser beam. By doing so, the second laser beam and the third laser beam can be modulated by using a single modulator (the waveform indicated by the symbol W1 in FIG. 6 corresponds to the third laser beam). When the recording strategy in relation to the shortest mark according to the present invention is used, it is possible to form a mark having a width longer than the mark length, which contributes to the improvement in the recording density.

Further, according to the present invention, there is provided a method for manufacturing a master disk; comprising exposing the master disk in accordance with the master disk exposure method of the present invention; developing the photoresist layer after the exposure to form a resist pattern corresponding to the certain exposure pattern on the surface of the master disk; and performing reactive ion etching by using the resist pattern as a mask to manufacture the master disk.

The thickness of the photoresist film is decreased after the development in some cases as a result of the application of the exposure energy which does not arrive at the sensitivity L of the photoresist but which approximates to the sensitivity L, due to any partial overlap or superimposition of the laser beams on the photoresist layer. Even in such a situation, when the reactive ion etching (RIE) is performed by using the resist pattern with the decreased thickness as a mask, the remaining portions of the photoresist layer are not etched by the reactive ion etching as far as the photoresist layer remains. Therefore, when the reactive ion etching is performed after the development, it is possible to correctly form the pit pattern corresponding to the pattern exposed with the high intensity laser beam. It is also possible to enhance the margin of the exposure energy during the exposure of the photoresist layer and the degree of freedom of the selection of the photoresist.

There is also provided an optical disk stamper which is replicated from the master disk obtained in accordance with the method of the present invention. The stamper, which is formed by using the master disk formed with the resist pattern as a master disk, makes it possible to replicate the substrate for the information-recording medium which is capable of recording the signal at the high density and which is capable of reducing the crosstalk and the jitter of the signal.

There is also provided a substrate for an information-recording disk which is formed by using the stamper of the present invention as a template, wherein the substrate includes a prepit in which a length in a direction perpendicular to a track direction is longer than a length in the track direction. When the prepit, in which the width in the direction perpendicular to the arrangement direction is larger than the length in the arrangement direction of the prepit array, is included in the prepit array as described above, then it is possible to remarkably improve the linear recording density of the information-recording medium, and it is possible to improve the recording capacity of the information-recording medium.

According to a second aspect of the present invention, there is provided a master disk exposure apparatus for forming a certain exposure pattern on a photoresist layer on a master disk for an information-recording medium by radiating a laser beam onto the master disk, the master disk exposure apparatus comprising:
a laser light source;
an optical modulator (53) which intensity-modulates the laser beam emitted from the laser light source in accordance with an exposure signal and which separates the laser beam into two beams (51, 52) having mutually opposite phases;
a beam divider (32) which divides one beam of the two beams (51, 52);
a collecting radiation position adjuster which adjusts radiation positions so that the one beam divided by the beam divider is radiated onto both sides of a radiation position of the other beam of the two beams (51, 52) on the photoresist layer; and
an intensity adjuster which adjusts an intensity of the one beam to be lower than a sensitivity of the photoresist layer.

According to a third aspect of the present invention, there is provided a master disk exposure apparatus for forming a certain exposure pattern on a photoresist layer on a master disk for an information-recording medium by radiating a laser beam onto the master disk, the master disk exposure apparatus comprising:
a laser light source;
a first beam divider which separates the laser beam radiated from the laser light source into first and second beams;
a first optical modulator which intensity-modulates the first beam divided by the first beam divider in accordance with an exposure signal;
a second optical modulator which intensity-modulates the second beam divided by the first beam divider in accordance with a signal having a phase opposite to that of the exposure signal;
a second beam divider which divides the second beam intensity-modulated by the second optical modulator;
a collecting radiation position adjuster which adjusts radiation positions so that the second beam divided by the second beam divider is radiated onto both sides of a radiation position of the first beam on the photoresist layer; and
an intensity adjuster which adjusts an intensity of the second beam to be lower than a sensitivity of the photoresist layer.

When the master disk exposure apparatuses according to the second and third aspects of the present invention are used, then it is possible to suppress the variation or fluctuation of the pit shape and the pit size which would be otherwise caused by the occurrence of the overlap, and it is possible to reduce the crosstalk and the jitter of the high density information-recording medium by carrying out the master disk exposure method of the present invention. In particular, when the optical modulator of the master disk exposure apparatus according to the second aspect is used, then the intensity of the laser beam can be modulated in accordance with the exposure signal, and the laser beam can be simultaneously separated into the two beams having the mutually opposite phases. That is, the high intensity laser beam and the low intensity laser beam, which are used in the present invention, can be generated by using the single optical modulator. Therefore, it is unnecessary to provide a plurality of modulators, and it is possible to produce the master disk exposure apparatus in a compact form at low cost.

The optical modulator may be an acousto-optical modulator. The light beam comes into the compression progressive wave of the acousto-optical modulator to cause the diffraction. Accordingly, the incident light beam may be divided into two, i.e., the 0th order diffracted light and the 1st order diffracted light as the two beams with ease. The intensity adjuster may be an attenuator. The master disk exposure apparatus may further comprise a half wave plate through which the one beam passes, and a polarizing beam splitter which combines the one beam and the other beam. When the half wave plate and the polarizing beam splitter are used, the three beams including the one beam (divided beam) and the other beam can be combined by using the simple arrangement.

The intensity adjuster may adjust the intensity of the one beam to be less than ½ of the sensitivity of the photoresist layer. The one beam, i.e., the low intensity laser beam is radiated so that the outer edge of the beam spot is overlapped with the outer edge of the spot of the high intensity laser beam to be radiated onto the pit area. In this situation, in relation to the energy of the beams to be radiated onto the overlapped portion, it is necessary to provide the energy of such an extent that the outer edges of the spots of the high intensity laser beam are overlapped, i.e., the energy of such an extent that the overlap arises. On the other hand, the spots of the low intensity laser beam may be overlapped with each other depending on the pit pattern intended to be formed. In this case, if the energy, which exceeds the sensitivity L of the photoresist, is applied to the overlapped portion of the spots, any pit is formed in an unintended area as a result of the development. Therefore, the intensity of the low intensity laser beam may be set so that the two-fold value thereof does not exceed the sensitivity L of the photoresist, i.e., the intensity is less than ½ of the sensitivity L of the photoresist.

The beam divider may be a diffraction grating or a phase shift plate. The phase shift plate makes it possible to separate the beam with the narrow spacing distance as compared with the diffraction grating. Therefore, the phase shift plate is preferably usable for exposing the master disk for the high density recording.

In the master disk exposure apparatus of the present invention, the second optical modulator may include a signal-cutting circuit. The second beam divider may be a diffraction grating which separates the laser beam into plus 1st order diffracted light and minus 1st order diffracted light. The second beam divider may be an acousto-optical deflector which separates the laser beam into plus 1st order diffracted light and minus 1st order diffracted light.

In the master disk exposure apparatus according to the third aspect of the present invention, the intensity adjuster may be an attenuator. The master disk exposure apparatus may further comprise a half wave plate through which the first beam passes, and a polarizing beam splitter which combines the first beam and the second beam. The intensity adjuster may adjust the intensity of the second beam to be less than ½ of the sensitivity of the photoresist layer.

### BRIEF DESCRIPTION OF THE DRAWINGS

FIG. 1 shows a plan view illustrating a master disk exposure apparatus of Embodiment 1-1.

FIG. 2 shows a side view illustrating focusing system of the master disk exposure apparatus of Embodiment 1-1.

FIGS. 3A to 3D illustrate the exposure waveform of the laser beam radiated from the master disk exposure apparatus of Embodiment 1-1 and the exposure state of a master disk for an optical disk.

FIG. 4 conceptually shows another example of a second beam divider provided for the master disk exposure apparatus shown in FIG. 1.

FIG. 5 shows a graph illustrating the relationship between the length and the width for prepits subjected to the cutting by using a master disk exposure apparatus of Embodiment 1-2.

FIGS. 6A to 6D illustrate another example of the exposure waveform of the laser beam radiated from the master disk exposure apparatus of Embodiment 1-2 and the exposure state of a master disk for an optical disk.

FIG. 7 shows a graph illustrating the relationship between the length and the width for prepits subjected to the cutting by using a master disk exposure method of Embodiment 1-2.

FIGS. 8A to 8C illustrate still another example of the exposure waveform of the laser beam radiated from a master disk exposure apparatus of Embodiment 1-3 and the exposure state of a master disk for an optical disk.

FIG. 9 shows a graph illustrating the relationship between the length and the width for prepits subjected to the cutting by using a master disk exposure method of Embodiment 1-3.

FIG. 10 shows a plan view illustrating a master disk exposure apparatus of Embodiment 2.

FIG. 11 shows a graph illustrating the waveforms of the exposure signal, the 1st order diffracted light, and the 0th order diffracted light obtained from an acousto-optic effect optical modulator provided for the master disk exposure apparatus of Embodiment 2.

FIG. 12 shows a schematic view illustrating a master disk exposure apparatus used in Embodiment 3.

FIG. 13 shows a perspective view illustrating a phase mask used for the master disk exposure apparatus of Embodiment 3.

FIG. 14 shows a graph illustrating the intensity distribution of the laser spot cross section on the master disk when the phase shift mask is not used.

FIG. 15 shows a graph illustrating the intensity distribution of the laser spot cross section on the master disk when the phase shift mask is used.

FIGS. 16A to 16D illustrate the exposure waveform of the laser beam radiated from the master disk exposure apparatus of Embodiment 3 and the exposure state of a master disk for an optical disk.

FIG. 17 shows a graph illustrating the relationship between the length and the width for prepits subjected to the cutting by using a master disk exposure method of Embodiment 3.

FIG. 18 shows a graph illustrating the relationship between the length and the width for prepits subjected to the cutting by means of a method concerning an exemplary conventional technique.

FIGS. 19A and 19B conceptually illustrate the principle of the present invention as compared with the conventional method.

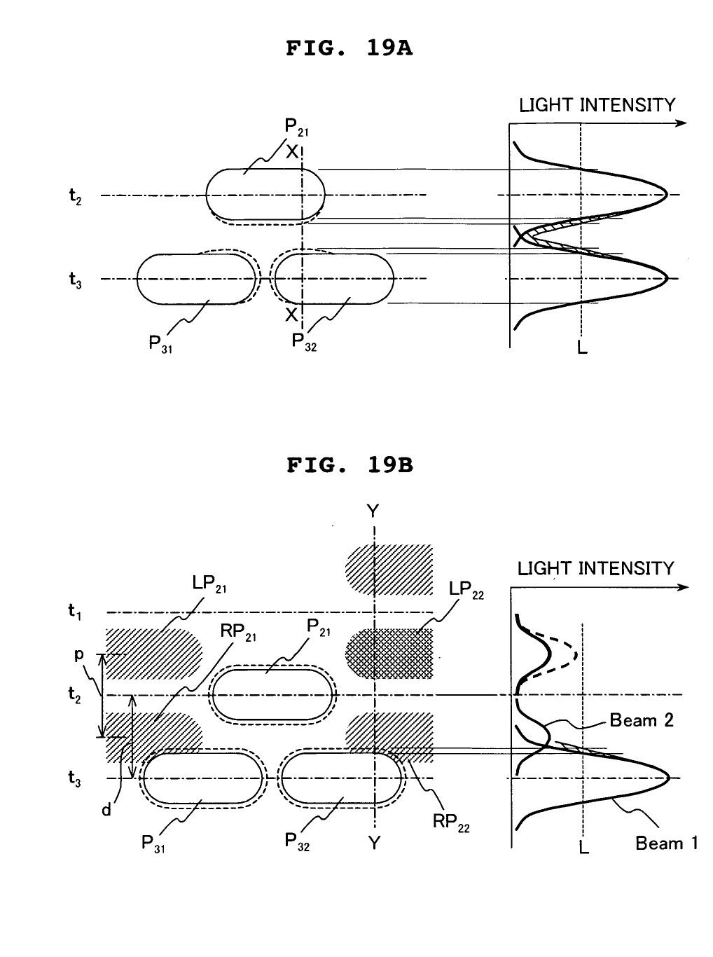

FIG. 20 illustrates the principle of appearance of the low exposure portion.

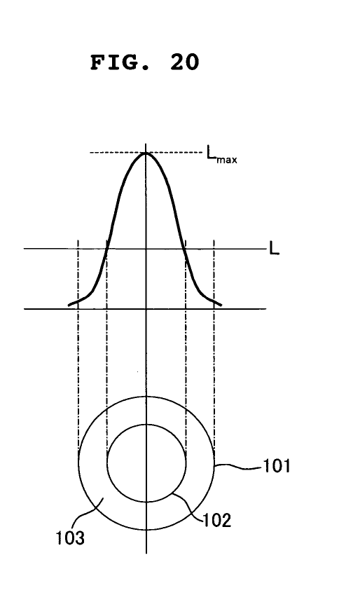

FIG. 21 illustrates the principle of appearance of the overlap.

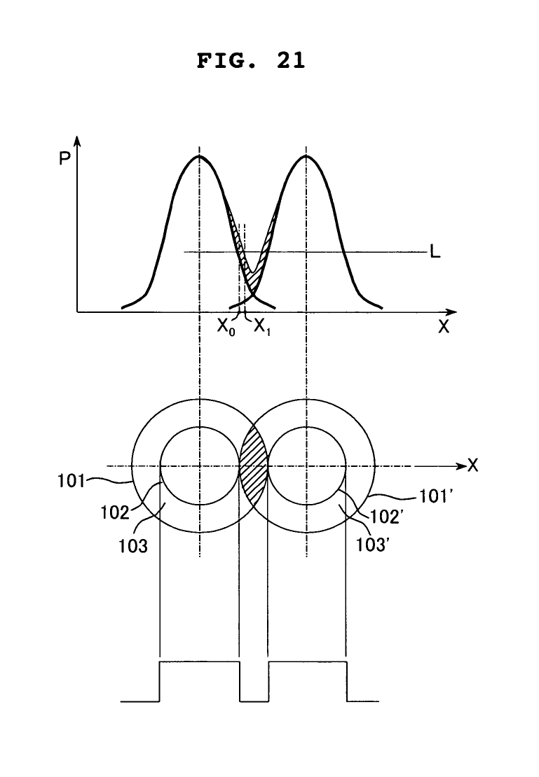

FIGS. 22A to 22C illustrate the exposure waveform of the laser beam radiated from a master disk exposure apparatus concerning an exemplary conventional technique and the exposure state of a master disk for an optical disk.

### DESCRIPTION OF THE PREFERRED EMBODIMENTS

### Embodiment 1-1

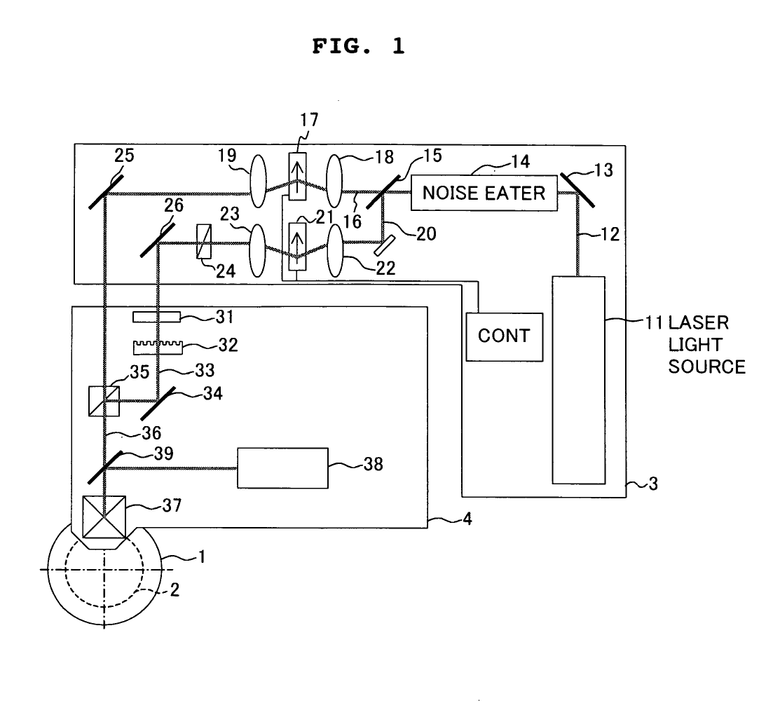

The master disk exposure apparatus, the master disk exposure method, the substrate for the information-recording medium, and the related features of the present invention will be explained below with reference to FIGS. 1 to 5 as exemplified by an exposure apparatus for a master disk for an optical disk, an exposure method for the master disk for the optical disk, and a substrate for the optical disk.

As shown in FIG. 1, a master disk exposure apparatus for an optical disk of this embodiment principally includes a master disk 1 for the optical disk, a turn table 2 which drives and rotates the master disk 1 for the optical disk, a fixed table 3 which is fixed at a predetermined position, and a movable table 4 which is arranged between the turn table 2 and the fixed table 3.

The master disk 1 for the master disk includes a photoresist layer having a uniform thickness which is formed, for example, on a surface of a smooth disk-shaped substrate made of glass.

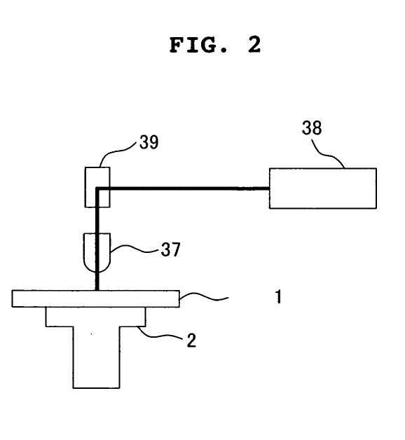

As shown in FIG. 2, the master disk 1 for the optical disk is detachably installed to the turn table 2. The installed master disk 1 for the optical disk is rotated in accordance with a required rotary driving system. The rotary driving system for the master disk 1 for the optical disk includes the CAV system, the ZCAV system, and the CLV system. The rotary driving system is selected depending on the optical disk to be produced.

Those provided on the fixed table 3 include a laser light source 11, a first mirror 13 which changes the optical path for a laser beam 12 radiated from the laser light source 11, a noise eater 14 which removes the noise contained in the laser beam 12, a half mirror (first beam divider) 15 which divides the laser beam 12 into two, a first acousto-optical modulator (hereinafter abbreviated as “first optical modulator”) 17 which intensity-modulates the first laser beam 16 divided by the half mirror 15 in accordance with an exposure signal for a pit array to be subjected to the cutting on the master disk 1 for the optical disk, a first lens 17 which regulates the angle of incidence of the first laser beam 16 into the first optical modulator 17, and a second lens 19 which adjusts the optical path for the first laser beam 16 passed through the first optical modulator 17. Further, those carried on the fixed table 3 include a second acousto-optical modulator (hereinafter abbreviated as “second optical modulator”) 21 which intensity-modulates the second laser beam 20 divided by the half mirror 15 in accordance with a phase of modulated signal approximately opposite to the exposure signal, a third lens 22 which regulates the angle of incidence of the second laser beam 20 into the second optical modulator 21, a fourth lens 23 which adjusts the optical path for the second laser beam 20 passed through the second optical modulator 21, a half wave plate 24 which rotates, by 90 degrees, the polarization axis of the second laser beam 20 passed through the fourth lens 23, a second mirror 25 which changes the optical path for the first laser beam 16 toward the movable table 4, and a third mirror 26 which changes the optical path for the second laser beam 20 toward the movable table 4. A control system (CONT), which is used to drive the first optical modulator 17 and the second optical modulator 21, is also provided on the fixed table 3.

As schematically shown in FIG. 1, the first lens 18 makes the first laser beam 16 to come in the traveling direction of the compression progressive wave in the first optical modulator 17. The third lens 22 makes the second laser beam 20 to come in the direction opposite to the traveling direction of the compression progressive wave in the second optical modulator 21. Accordingly, the frequency of the first laser beam 16 diffracted by the first optical modulator 17 and the frequency of the second laser beam 20 diffracted by the second optical modulator 21 are subjected to the Doppler shift respectively. The shifted frequency components have mutually opposite signs. As a result, the difference in frequency arises between the light beams generated by the optical modulators 17, 21. Therefore, the light beams, which are modulated by the two optical modulators 17, 21, are prevented from any mutual interference.

As shown in FIGS. 1 and 2, a movable optical system is carried on the movable table 4, the movable optical system including an attenuator 31 which adjusts the laser intensity of the second laser beam 20 intensity-modulated by the second optical modulator 21, a diffraction grating (second beam divider) 32 which divides the second laser beam 20 having the laser intensity adjusted by the attenuator 31 into 0th order diffracted light and ±1st order diffracted lights, a fourth mirror (collecting radiation position adjuster) 34 which changes the optical path for the ±1st order diffracted light 33 obtained by the diffraction grating 32, a polarizing beam splitter 35 which combines the ±1st order diffracted light 33 with the first laser beam 16 intensity-modulated by the first optical modulator 17, an objective lens 37 which collects the combined laser beam 36 onto the photoresist layer of the master disk 1 for the optical disk, a focus detector 38 which detects the defocus of the objective lens 37, and a dichroic mirror 39 which introduces the reflected light beam from the master disk 1 for the optical disk into the focus detector 38. The movable table 4 is movable with respect to the master disk 1 for the optical disk within a predetermined range so that the objective lens 37 is transported in the radial direction of the master disk 1 for the optical disk. FIG. 2 shows the arrangement relationship in relation to the objective lens 37, the focus detector 38, the dichroic mirror 39, and the master disk 1 for the optical disk.

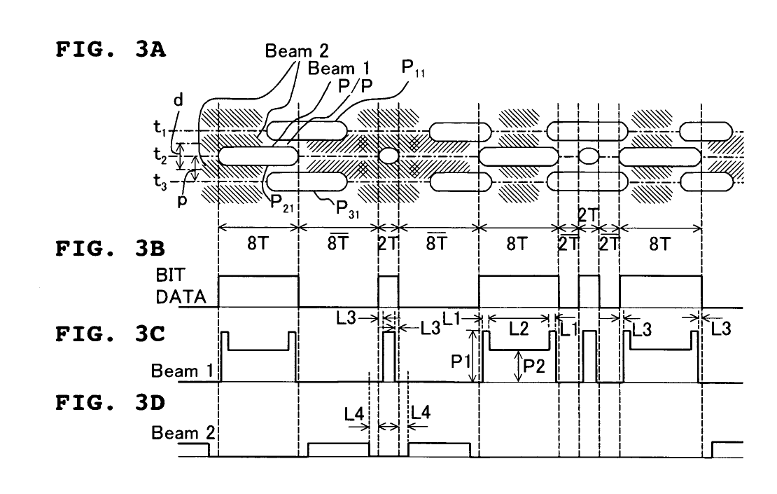

FIGS. 3C and 3D show waveforms of the first laser beam 16 and the second laser beam 20 to be radiated onto the master disk 1 for the optical disk respectively. As shown in FIGS. 3C and 3D, the first laser beam 16 and the second laser beam 20, which are radiated onto the master disk 1 for the optical disk, have the opposite phases (ON/OFF timings). Basically, the second laser beam 20 is turned OFF during the ON period of the first laser beam 16, and the second laser beam 20 is turned ON during the OFF period of the first laser beam 16. The turning timings are controlled by driving signals for the modulators supplied from the control system (CONT) to the first optical modulator 17 and the second optical modulator 21. More specifically, as exemplified in FIG. 3C, the first optical modulator 17 adjusts the pulse width L1 at the front end and the rear end in the exposure waveform, the cutting L3, the waist length L2 of the mark of not less than 3T, the laser intensity P1 at the front end and the rear end, and the laser intensity P2 of the waist portion. Further, the first optical modulator 17 intensity-modulates the first laser beam 16 so that the laser intensity P1 has a predetermined value of not less than the sensitivity of the photoresist layer. As shown in FIG. 3D, the second optical modulator 21 intensity-modulates the second laser beam 20 so that the cutting of the pulse width L4 is added at the front end and the rear end in the exposure waveform.

For example, an attenuation filter or a wavelength plate may be used as the attenuator 31. The laser intensity of the second laser beam 20, which has been intensity-modulated by the second optical modulator 21, is adjusted by the attenuator 31 so that the laser intensity is lower than the sensitivity L of the photoresist layer, and especially the laser intensity is less than ½ of the sensitivity L as shown in FIG. 3D.

As described above, the second laser beam, which has passed through the attenuator 31, is divided by the diffraction grating 32 into the 0th order diffracted light and the ±1st order diffracted lights. However, there is such a possibility that the 0th order diffracted light may be overlapped with the first laser beam 16 in the polarizing beam splitter 35, which may make it difficult to control the intensity of the first laser beam 16 to be radiated onto the master disk for the optical disk. Therefore, as for the diffraction grating 32, in order to avoid any harmful influence of the 0th order diffracted light, it is preferable to use such a diffraction grating that the intensity of the 0th order diffracted light is lower than the intensity of the ±1st order diffracted light, and especially the intensity of the 0th order diffracted light is not more than ⅕ of the intensity of the ±1st order diffracted light.

The ±1st order diffracted light 33 (Beam 2), which is obtained by the diffraction grating 32, is radiated by the fourth mirror 34 via the polarizing beam splitter 35, the dichroic mirror 39, and the objective lens 37 onto both side portions of the radiation position of the laser beam 16 (Beam 1) intensity-modulated by the first optical modulator 17. FIG. 3A shows a pit pattern exposed with Beam 1 and Beam 2 together with pattern lengths (for example, 2T and 8T). In this case, in order to uniformize the exposure amounts of the laser beams 16, 33 at portions at which no pit is formed, the radiation spacing distance d on the master disk 1 for the optical disk of the ±1st order diffracted light 33 is adjusted to be almost equal to the pitch (track pitch) p of the pit array subjected to the cutting on the master disk 1 for the optical disk as shown in FIG. 3A. The ±1st order diffracted light 33 is radiated so that the radiation positions of the ±1st order diffracted light 33 on the master disk 1 for the optical disk are positioned at equal distances from the center (track center) of the pit array respectively. That is, Beam 2 is radiated onto the boundary between the adjacent tracks. When the radiation position of the ±1st order diffracted light is adjusted as described above, the light energy, which is equivalent to the energy to be obtained when the overlap appears, can be given to the outer circumferential portions of the adjacent track pitch-forming areas.

In FIG. 3A, the hatched areas indicate areas which are exposed with Beam 2. Of the tracks t₁ to t₃ shown in FIG. 3A, the pit pattern on the track t₂ is subjected to the exposure in accordance with the waveform (0 or 1) shown in FIG. 3B. When the bit data is absent (0 signal), then Beam 1 is not radiated, and Beam 2 is radiated instead thereof on the both sides of the track center as shown in FIGS. 3C and 3D. As a result, the area, in which the pit (exposure mark) is not formed, is exposed with Beam 2 having the low power. The power of Beam 2 is about 10% of the power of the peak power P1 of Beam 1. The power of Beam 2 is preferably less than 50% and especially preferably 5 to 12% with respect to the sensitivity L of the photoresist.

The overlap arises in the area P/P interposed between the pit P₁₁ on the track t₁ and the pit P₂₁ on the track t₂, because outer extending portions (outer circumferential portions of the beam spots) of Beam 1 having the high power for exposing the pit P₁₁ and the pit P₂₁ are overlapped with each other. That is, the light energy brought about by the overlap is given to the area P/P. Therefore, all of the areas are exposed with any one of the light beams (Beam 1, Beam 2, and the light beam based on the overlap) on the photoresist on the master disk shown in FIG. 3A.

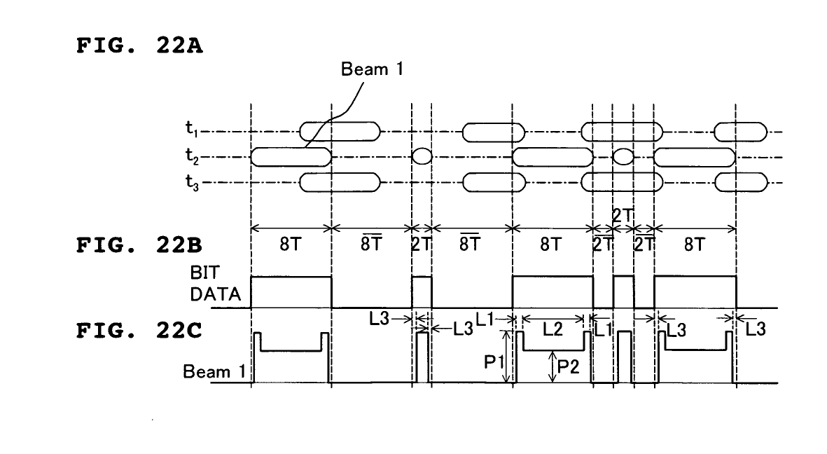

The cutting (exposure and development) was carried out for the master disk for the optical disk by using the master disk exposure apparatus as described above. The cutting condition was the same as that used for the exemplary conventional technique shown in FIG. 22, which was as follows. As shown in FIGS. 3A and 3B, the bit data composed of the random waveform, in which the shortest was 2T and the longest was 8T in the (1, 7) RLL waveform, was subjected to the cutting on the master disk for the optical disk. In order to realize a recording capacity of 27 GB for the CD size, the following recording strategy was used. The length of T was 69.5 nm, the pulse width L1 at the front end and the rear end of the exposure waveform was L1=0.6T, the cutting L3 was L3=T−L1, the waist length L2 of the marks of not less than 3 T was L2=(n−2)T, and the relationship between the laser intensity P1 at the front end and the rear end and the laser intensity P2 at the waist portion was P2=P1>(L1/T). The master disk for the optical disk was used, on which an i-line resist produced by TOKYO OHKA KOGYO CO., LTD. was applied to have a thickness of 75 nm. The bit data was subjected to the cutting by using the master disk exposure apparatus in which the wavelength of the laser beam was 257 μm, and the numerical aperture of the objective lens was 0.9.The surface shape of the pit, which was obtained after performing the development process for the master disk for the optical disk, was observed by using AFM.

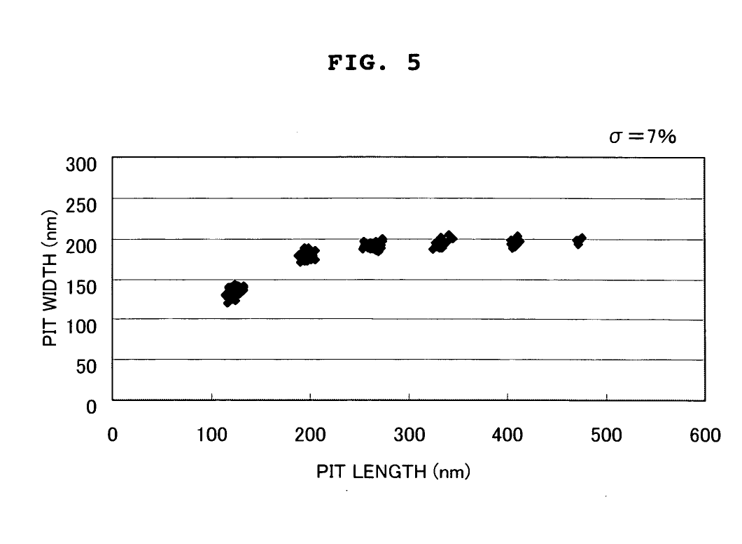

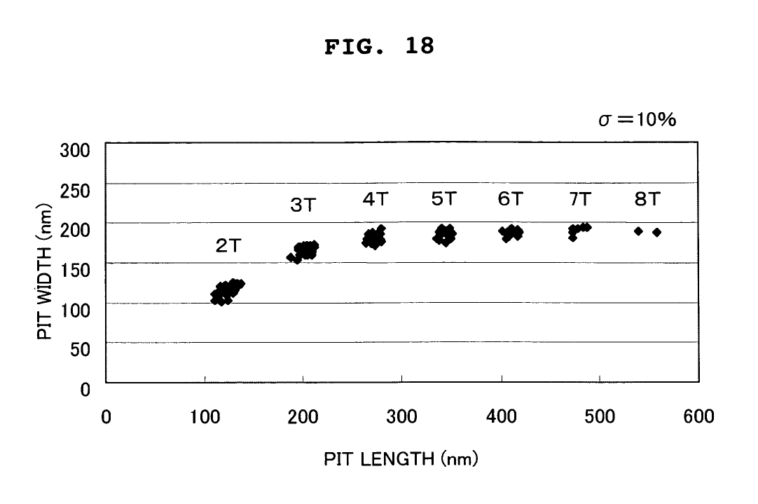

FIG. 5 shows the relationship between the widths and the lengths of the prepits subjected to the cutting. FIG. 5 shows the distribution of the widths and the lengths of the pits, obtained by observing the lengths and the widths with AFM after forming the pits of 2T to 8T. According to this result, it is appreciated that the dispersion of the length is suppressed for the pit of any one of the length as compared with the exemplary conventional technique (see FIG. 18). It has been revealed that the standard deviation of the difference among the nominal length of all pits is 7%. According to this result, the following fact is appreciated. That is, the situation, which is the same as that of the overlap generated around the portion irradiated with the high intensity laser beam, is produced by substitutively radiating the low intensity laser beam 33 onto the predetermined area at the timing at which the high intensity laser beam 16 is not radiated, by using the master disk exposure apparatus according to the embodiment of the present invention. Thus, it is possible to avoid the variation or fluctuation of the size of the pit or the space, which would be otherwise caused by the presence or absence of the overlap. That is, in the method of the present invention, the exposure state, which is the same as that of the overlap, is forcibly generated over the entire area of the photoresist on the master disk. Therefore, the influence of the overlap on the pit dimension, which is caused only when the high intensity laser beam 16 is radiated onto the two adjacent areas, is uniformized.

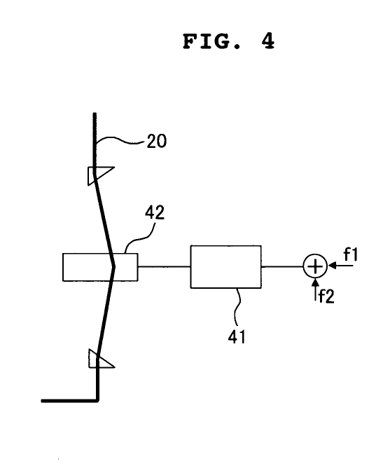

In the master disk exposure apparatus described above, for example, a combination of a mirror and a plurality of half mirrors and a wedge prism may be used as the second beam divider in place of the diffraction grating 32. Other than the optical parts as described above, as shown in FIG. 4, it is also possible to use an acousto-optical laser beam deflector 42 into which signals f1, f2 of two frequencies are inputted into the input end of a driver circuit 41. When the signals f1, f2 of the two frequencies are inputted into the acousto-optical laser beam deflector 42, the incident laser beam can be divided into two beams depending on the frequencies thereof. When the acousto-optical laser beam deflector 42 is used, the divided laser beams having predetermined intensities can be arbitrarily generated by changing the input signals f1, f2, unlike the case of the use of the optical part such as the diffraction grating and the wedge prism. Therefore, it is possible to arbitrarily adjust the exposure intensity to be brought about on the land portion and the spacing distance of the laser beam 33 divided by the acousto-optical laser beam deflector 42. It is possible to more correctly control the space length and the pit length of the pit formed in the pit array.

### Embodiment 1-2

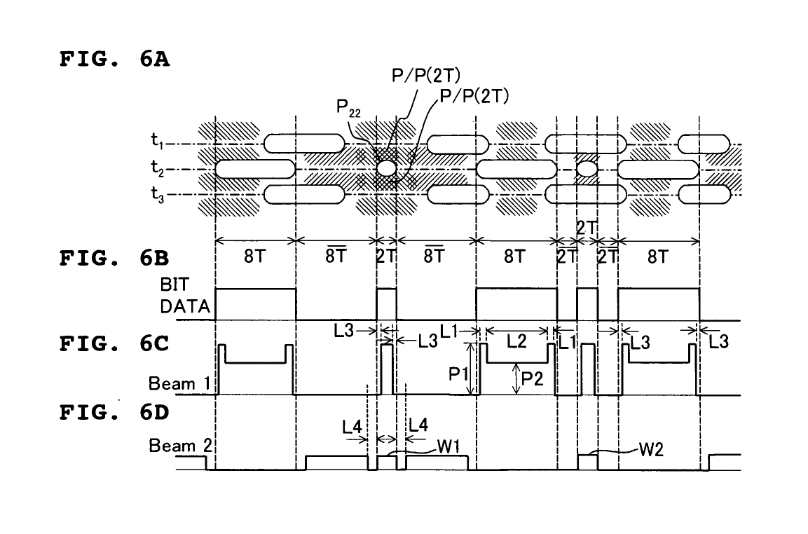

FIG. 6 shows another specified embodiment of the master disk exposure method based on the use of the master disk exposure apparatus explained in Embodiment 1-1. In this embodiment, a pit exposure pattern was formed in the same manner as in Embodiment 1-1 except that the driving signal to be supplied to the second optical modulator was changed by using the control unit (CONT) of the master disk exposure apparatus. As shown in FIG. 6A, the same pit patterns as those in Embodiment 1-1 are formed on the tracks t₁ to t₃ respectively. The bit data for exposing the track t₂ (FIG. 6B) and the waveform of the exposure light beam (FIG. 6C) are also the same as those in Embodiment 1-1. However, as for Beam 2, the pattern, which was reverse to that of Beam 1, was used in Embodiment 1-1. However, in this embodiment, as indicated with the track t₂ in FIG. 6A, Beam 2 was also radiated on the areas P/P (2T) disposed on the both sides when the shortest pit P₂₂ (length: 2T) was irradiated with Beam 1. That is, as also appreciated from the waveforms w1 and w2 in FIG. 6D, the low exposure power beam is radiated onto the both sides of the pit (recording mark) when the shortest pit having the length of 2T is formed. In the situations other than the above, the low exposure power beam is radiated only when the pit is not formed. The radiation spacing distance d between two Beam 2's is the same as the track pitch p.

According to the master disk exposure method of this embodiment, the low intensity laser beam 33 is radiated onto the adjacent portion of the shortest pit. Therefore, the width of the shortest pit, which tends to be narrowed in the width as compared with those of the pits having the other lengths, is widened. Accordingly, it is possible to further uniformize the pit width irrelevant to the pit length. In particular, in relation to the shortest pit, the width (average value: about 170 nm) can be made to be larger than the length (average value: about 140 nm). Therefore, when the master disk exposure method of this embodiment is used, it is possible to reliably form the pit having the long width irrelevant to the pit length. Therefore, it is possible to provide a recording medium on which the recording can be performed at higher densities in the linear direction (track direction).

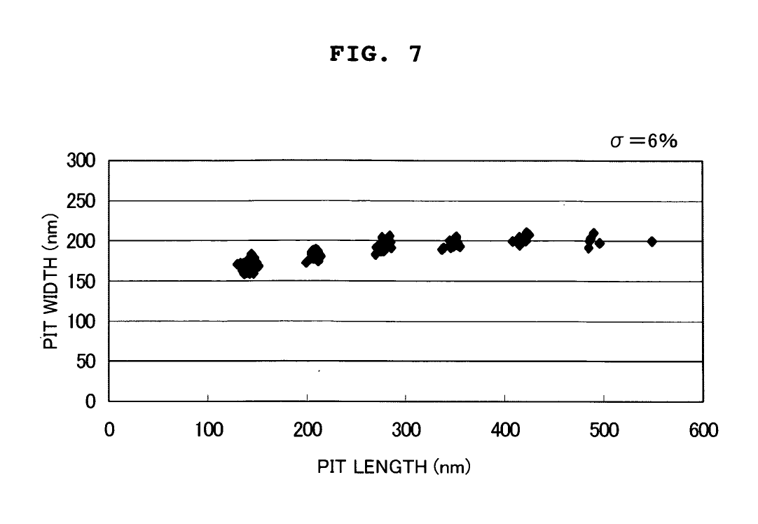

The surface shape of the pit subjected to the cutting in accordance with the same condition and the same recording strategy as those used in Embodiment 1-1 was measured by using the same method as that used in Embodiment 1-1. Obtained results of the measurement are shown in FIG. 7. As shown in FIG. 7, the pit width of the shortest pit (2T) is at approximately the same level as those of the pits having the other lengths. It is appreciated that the uniformity of the pit width is considerably improved as compared with the exemplary conventional technique (FIG. 18) and Embodiment 1-1 (FIG. 5). Further, the standard deviation of the dispersion of the respective pit lengths was successfully suppressed to be 6%.

In this embodiment, the waveforms w1 and w2 in FIG. 6D can be also recognized as the third laser beam. A modulator or a light source, which generates the third laser beam, may be actually provided separately from the modulator or the light source for generating the first and second laser beams.

### Embodiment 1-3

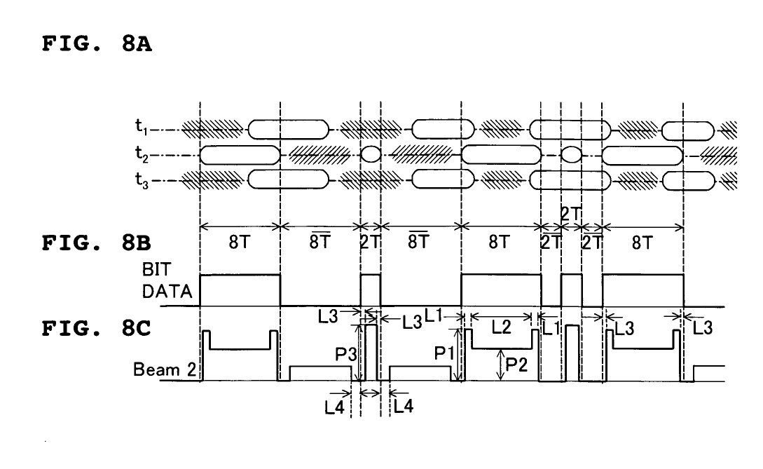

FIG. 8 shows still another embodiment of the master disk exposure method based on the use of the master disk exposure apparatus explained in Embodiment 1-1. In this embodiment, the radiation, which is effected with Beam 1 and Beam 2 in Embodiments 1-1 and 1-2, is executed with a single laser beam by switching the power of the laser beam to the high intensity and the low intensity. Specifically, in the master disk exposure apparatus shown in FIG. 1, the driving of the second optical modulator 21 is stopped, and the modulation waveform with the first optical modulator 17 is controlled by the control unit (CONT). Accordingly, as shown in FIG. 8C, Beam 2, which has the waveform of two types of powers of the high intensity and the low intensity, is radiated. Therefore, the locus of the beam is on the track center (see the track t₂) in relation to any one of the beam having the high intensity power and the beam having the low intensity power. In this embodiment, the laser intensity P3, which is used when the shortest pit is exposed, is relatively strengthened by about 5% as compared with the laser intensity P1 which is used when the other pits are exposed. The exposure intensity P1 of the low intensity laser beam is increased as compared with those used in the master disk exposure methods in Embodiments 1-1 and 1-2. The other cutting condition and the measuring condition for the pit surface shape were the same as those in Embodiment 1-1.

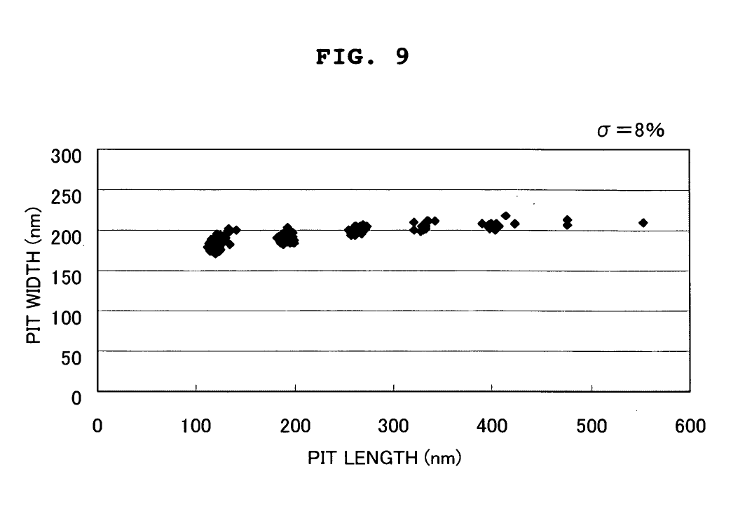

The surface shape of the pit subjected to the cutting in accordance with the same condition and the same recording strategy as those used in Embodiment 1-1 was measured by using the same method as that used in Embodiment 1-1. Obtained results of the measurement are shown in FIG. 9. As shown in FIG. 9, the degree of dispersion of the pit length of the pit having each length is somewhat improved. Further, the following fact is appreciated. That is, the pit width of the shortest pit is at approximately the same level as those of the pits having the other lengths, which is considerably improved especially as compared with the exemplary conventional technique (FIG. 18) and Embodiment 1-1 (FIG. 5). Further, the standard deviation of the dispersion of the pit length of the shortest pit was successfully suppressed to be 8%. A shallow depression was formed at the portion irradiated with the low intensity laser beam in a developed state on the photoresist layer of the master disk 1 for the optical disk subjected to the cutting in accordance with the master disk exposure method of this embodiment, probably for the following reason. That is, it is considered that the shallow depression is formed due to the fact that the exposure intensity P1 of the low intensity laser beam is increased as compared with those used in the master disk exposure methods of Embodiments 1-1 and 1-2.

### Embodiment 2

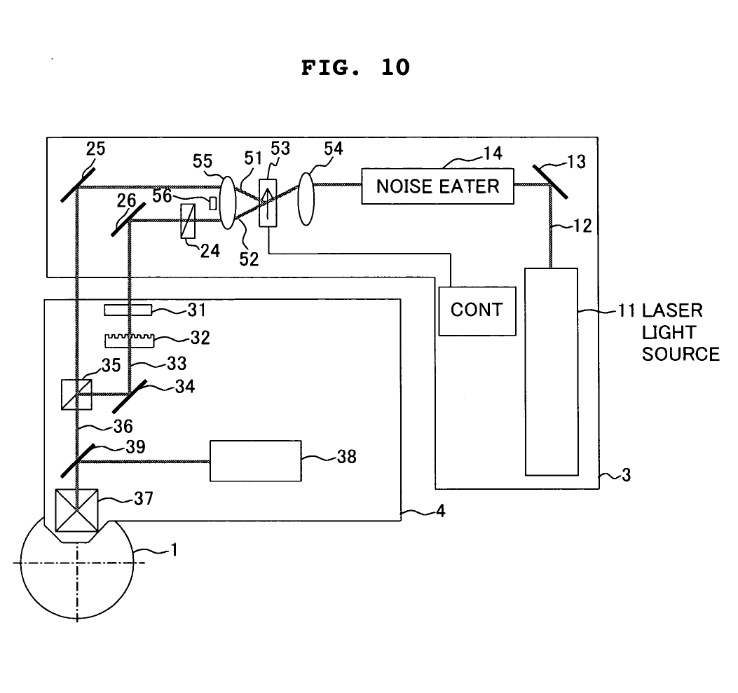

Next, a second embodiment of the master disk exposure apparatus and the master disk exposure method according to the present invention will be explained with reference to FIG. 10.

As shown in FIG. 10, a master disk exposure apparatus of this embodiment principally includes a fixed table 3 which carries, for example, a light source and an optical modulator, a movable table 4 which carries, for example, a detector and a beam divider, and a turn table 2 (see FIG. 2) which rotatably supports a master disk 1 having a photoresist applied to the surface. Those provided on the fixed table 3 include a laser light source 11, a first mirror 13 which changes the optical path for a laser beam 12 radiated from the laser light source 11, a noise eater 14 which removes the noise contained in the laser beam 12, an acousto-optical modulator (hereinafter simply abbreviated as “optical modulator”) which separates the incoming laser beam 12 into 1st order diffracted light 51 and 0th order diffracted light 52, a first lens 54 which regulates the angle of incidence of the laser beam 12 into the optical modulator 53, a second lens 55 which takes out, as parallel light beams, the 1st order diffracted light 51 and the 0th order diffracted light 52 separated by the optical modulator 53, a shielding member 56 which is equipped to the second lens 55, a half wave plate 24 which rotates, by 90 degrees, the polarization axis of the 0th order diffracted light 52, a second mirror 26 which changes the optical path for the 1st order diffracted light 51 toward the movable table 4, and a third mirror 26 which changes the optical path for the 0th order diffracted light 52 toward the movable table 4. Those also provided on the movable table 4 include optical systems (31, 32, 34, 35, 37, 39) and a detector 38 in the same manner as in Embodiment 1-1. The same elements as those explained in Embodiment 1-1 are designated by the same reference numerals, any explanation of which will be omitted.

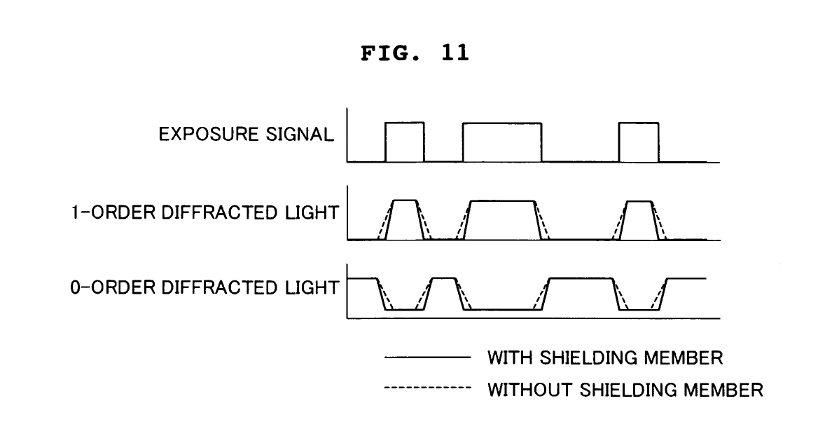

The laser beam 12 comes into the compression progressive wave generated by the optical modulator 53, and the laser beam 12 is divided by diffraction into the 1st order diffracted light 51 and the 0th order diffracted light 52. As a result of the diffraction, the diffracted light beams have mutually opposite phases as shown in FIG. 11. The 1st order diffracted light 51 is turned OFF during the ON period of the 0th order diffracted light 52, and the 1st order diffracted light 51 is turned ON during the OFF period of the 0th order diffracted light 52. That is, the optical modulator 53 separates the laser beam 12 into the two beams, and the optical modulator 53 modulates the intensity so that the two beams have the mutually opposite phases. The shielding member 56 is equipped to the second lens 55. Therefore, it is possible to more sharpen the rising and the falling of the 1st order diffracted light 51 and the 0th order diffracted light 52 (solid line portions in FIG. 11) as compared with a case in which no shielding member 56 is equipped (broken line portions in FIG. 11), for the following reason. That is, the shielding member 56 cuts off any stray light other than the 0th order light and the 1st order light. Therefore, the shielding member 56 makes it possible to further clarify the separation of the 1st order diffracted light 51 and the 0th order diffracted light 52.

The intensity of the separated 0th order diffracted light 52 is adjusted by the attenuator 31 in the same manner as Embodiment 1-1, and the 0th order diffracted light 52 is redivided by the diffraction grating 32 into ±1st order diffracted light 33. The redivided ±1st order diffracted light 33 is combined by the polarizing beam splitter 35 with the firstly divided 1st order diffracted light 51. In the same manner as in Embodiment 1-1, the 1st order diffracted light 51 is used as the high intensity laser beam for exposing the pits, and the redivided ±1st order diffracted light 33 is used as the laser beam having the intensity to expose the track boundary portions. The exposure timing can be controlled in the same manner as in Embodiment 1-1 as shown in FIGS. 3C and 3D.

When the master disk exposure apparatus and the master disk exposure method of this embodiment are used, then the influence of the overlap, which would be otherwise caused by the high intensity laser beam, can be avoided, and it is possible to suppress the jitter in the same manner as in the master disk exposure apparatuses used in Embodiments 1-1 and 1-2. In the case of the master disk exposure apparatus of this embodiment, it is enough to use the single optical modulator, and it is unnecessary to provide any signal source for the second optical modulator as well. Therefore, it is possible to produce the master disk exposure apparatus cheaply in a compact form.

### Embodiment 3

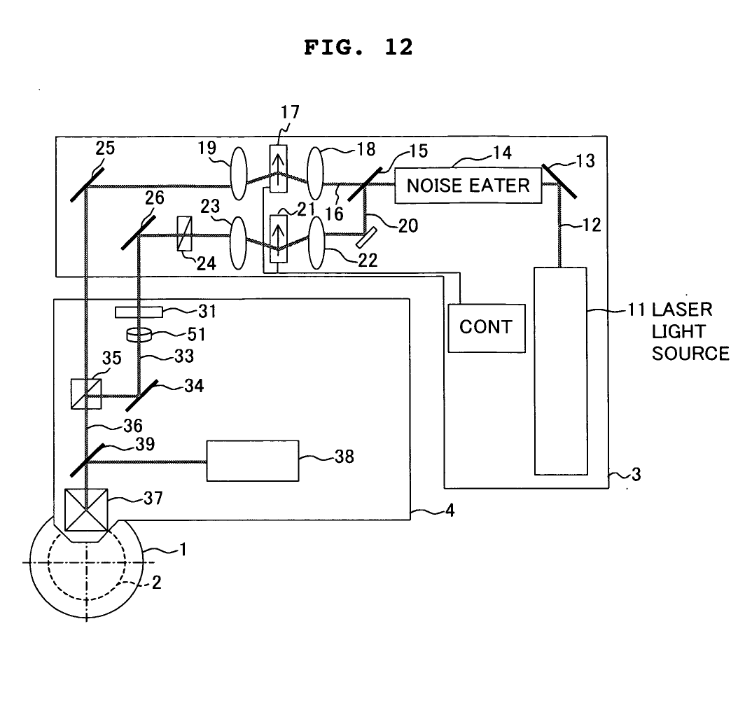

A master disk exposure apparatus shown in FIG. 12 was assembled in the same manner as in Embodiment 1-1 except that a phase shift mask 51 was used in place of the diffraction grating 32 of the master disk exposure apparatus used in Embodiment 1-1. The respective elements shown in FIG. 12 have been already explained in relation to FIG. 1, any explanation of which will be omitted.

The laser beam 12 having a wavelength of 257 nm, which comes from the laser light source 11, passes through the noise eater 14 to remove the noise, and then the laser beam 12 is divided into two by using the half mirror 15. The first laser beam 16 and the second laser beam 20 pass through the first optical modulator 17 and the second optical modulator 21 respectively. The first optical modulator 17 modulates the first laser beam 16 on the basis of the driving signal fed from the control circuit CONT so that the first laser beam 16 is modulated into the exposure light beam to form the pit pattern. The second optical modulator 21 modulates the second laser beam 20 on the basis of the driving signal fed from the control circuit CONT so that the second laser beam 20 is turned OFF when the first laser beam 16 is turned ON, and the second laser beam 20 is turned ON when the first laser beam 16 is turned OFF. In this embodiment, the adjustment is made by a delay circuit and a cutting or scraping circuit provided in the control circuit CONT so that the two laser beam signals are not overlapped with each other. Further, the attenuation is effected so that the intensity of the second laser beam 20 is an intensity of such an extent that the resist is not completely removed after the development, more specifically, an intensity less than ½ of the sensitivity L of the photoresist.

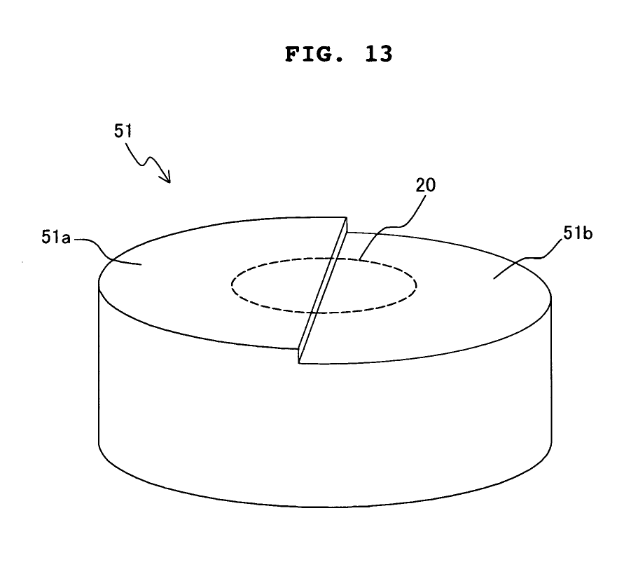

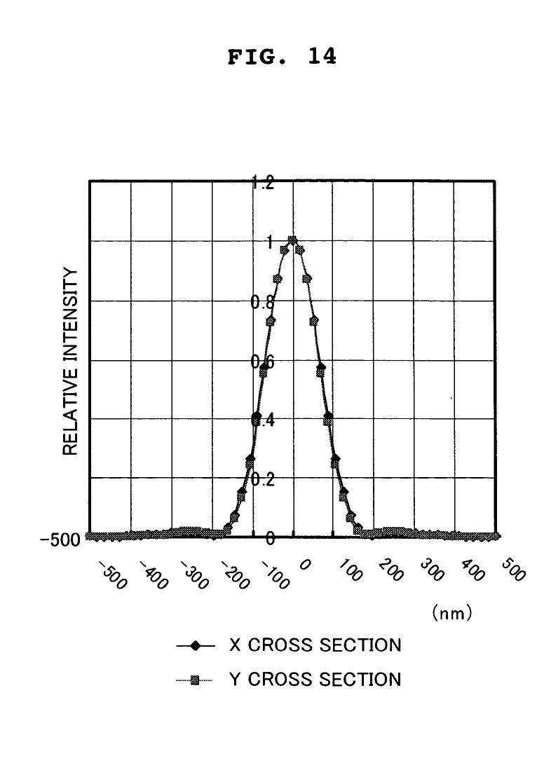

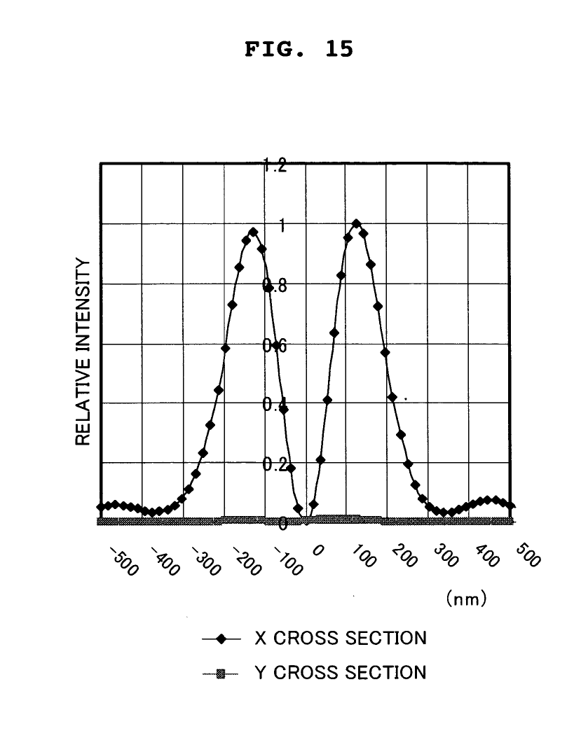

The second laser beam 20, for which the intensity and the ON/OFF timing have been modulated, passes through the half wave plate 24 to rotate the direction of polarization by 90°. After that, the second laser beam 20 passes through the attenuator 31, and comes into the phase shift mask 51. After that, The second laser beam 20 (33) is combined with the first laser beam 16 by the aid of the polarizing beam splitter 35, and the combined light beam is radiated onto the master disk 1 through the objective lens 37. The second laser beam 20 (33), which has passed through the phase shift mask 51, is divided into two by passing through the objective lens 37. The phase shift mask 51 is made of quartz glass. As shown in FIG. 13, the phase shift mask 51 includes a higher half portion 51a and a lower half portion 51b with a stepped portion having a height of 214 nm (corresponding to the phase difference n). When the laser beam 20 passes through the center of the mask including the stepped portion, the phase difference appears in the laser beam having passed through the higher half portion 51a and the lower half portion 51b. The two beams, which have passed through the higher half portion 51a and the lower half portion 51b, are different from each other by a half wavelength in relation to the phase difference. Therefore, the overlapped portions of the beams are counteracted with each other as a result of the interference, and the intensity is lowered at the center of the beam. Therefore, the second laser beam 20, which has an intensity distribution in laser spot cross sections observed in the absence of the phase shift mask 51 as shown in FIG. 14, is converted into the light beam which has an intensity distribution in laser spot cross sections as shown in FIG. 15 after passing through the phase shift mask 51 and the objective lens 37. In FIGS. 14 and 15, the X direction and the Y direction mean the radial direction and the circumferential direction of the master disk 1 respectively. The separation width of the second laser beam 20 (33) depends on the laser wavelength and the numerical aperture (NA) of the objective lens. In this embodiment, the employed objective lens had NA=0.9. The track pitch of the master disk was 320 nm, and the bit pitch was 69.0 nm.

This embodiment has the following advantage, because the phase shift mask 51 is used in place of the diffraction grating 32 used in the first embodiment, i.e., Embodiment 1-1. Firstly, in the case of the diffraction grating, the 0th order diffracted light is generated by the diffraction in addition to the 1st order diffracted light, and hence it is necessary to remove the 0th order diffracted light. On the contrary, it is unnecessary for the phase mask to remove the 0th order diffracted light. Secondly, the spacing distance between the two beams capable of being separated by the diffraction grating is determined by the laser wavelength and the grating constant of the diffraction grating. Therefore, it is difficult to obtain any narrow spacing distance. In particular, it is difficult that the beam spacing distance is not more than 300 nm by using the diffraction grating. However, the phase mask is advantageous in that the narrow spacing distance of not more than 300 nm is obtained. Accordingly, even when the track width is further narrowed as a result of the high recording density, then the low exposure beam or the low intensity beam is radiated at the predetermined spacing distance onto the both sides of the track according to the present invention, and it is possible to solve the problem of the overlap.

In this embodiment, the beam spacing distance was successfully 260 to 300 nm with respect to the track pitch of 320 nm of the master disk by using the phase mask. On the other hand, when the diffraction grating was used in place of the phase mask as in Embodiment 1-1, the beam spacing distance was 300 to 320 nm.

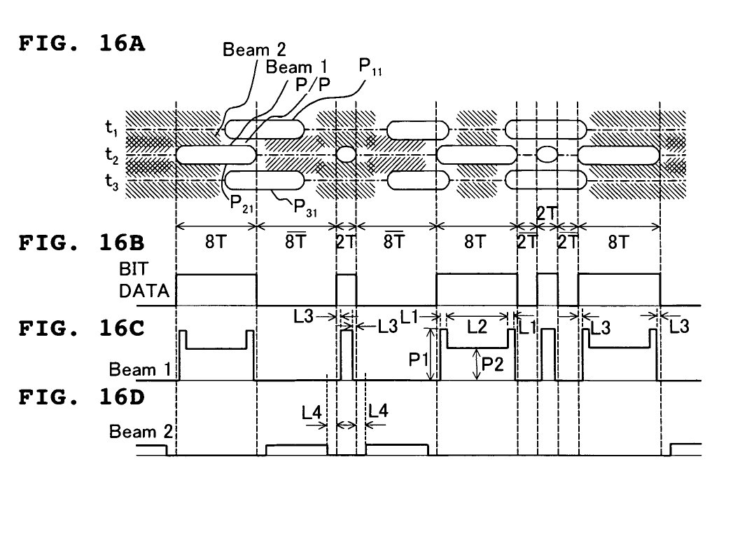

FIG. 16 shows the exposure pattern used in the exposure method of this embodiment. However, the exposure pattern itself is the same as that used in Embodiment 1-1. FIG. 16B shows the bit data for forming the pits on the track t₂. FIG. 16C shows the modulation pattern of the waveform of the high intensity laser beam 16 (Beam 1) modulated by the first optical modulator 17 in accordance with the bit data. FIG. 16D shows the modulation pattern of the waveform of the low intensity laser beam 33 (Beam 2) modulated by the second optical modulator 21 so that the phase is approximately opposite with respect to the bit data.

In the exposure waveform, the pulse width L1 at the front end and the rear end of the exposure waveform was L1=0.6T, the cutting L3 was L3=T−L1, the waist length L2 of the marks of not less than 3 T was L2=(n−2)T, and the relationship between the laser intensity P1 at the front end and the rear end and the laser intensity P2 at the waist portion was P2=P1×(L1/T). The intensity of Beam 2 was 10% of the intensity of Beam 1.

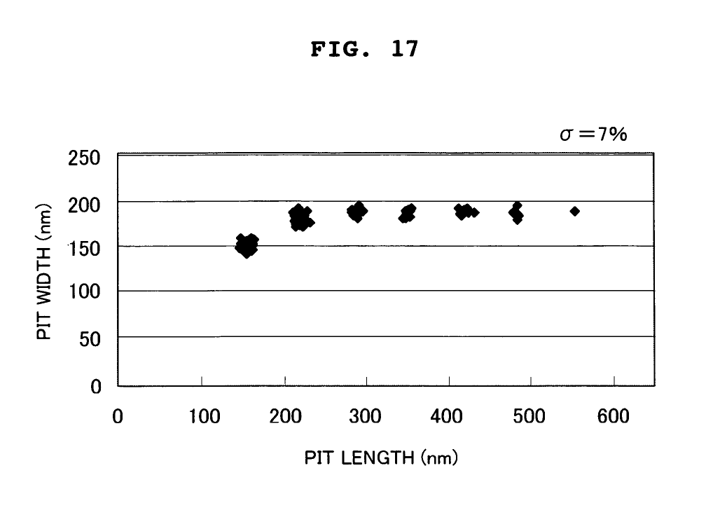

FIG. 17 shows the relationship between the width and the length of the prepit subjected to the cutting under the condition as described above. FIG. 17 illustrates the distribution of the width and the length of the pits, obtained by observing the lengths and the widths thereof by using AFM after forming the pits of 2T to 8T. The standard deviation a of the dispersion of the pit length was σ=7%. In particular, in this embodiment, the phase mask is used, and the low intensity laser beam is radiated onto the both sides of the track at the spacing distance less than the track pitch. Therefore, even in the case of the optical disk having a higher density, it is possible to suppress the dispersion of the width and the length of the pit of the same size on the basis of the present invention.

### Method for Producing Optical Disk Stamper

An optical disk stamper can be manufactured by performing a development process for the photoresist layer of the master disk 1 for the optical disk exposed in each of Embodiments described above, and transferring the developed resist pattern of the master disk 1 for the optical disk by, for example, the nickel plating.

Alternatively, a process based on the RIE treatment (reactive ion etching treatment) may be carried out as follows. The photoresist layer of the master disk 1 for the optical disk exposed in each of Embodiments is subjected to the development process to obtain the master disk 1 for the optical disk having the predetermined resist pattern. Subsequently, the RIE treatment is performed for the master disk 1 for the optical disk. In this procedure, the resist pattern acts as a mask. The pit pattern, which corresponds to the resist pattern formed on the surface of the master disk 1 for the optical disk, is obtained by the RIE treatment. The optical disk stamper can be manufactured by transferring the pit pattern by, for example, the nickel plating.

As described above, the optical disk stamper of the present invention can be manufactured by applying the transfer technique by using the master disk 1 for the optical disk exposed by the master disk exposure apparatus and the master disk exposure method of each of Embodiments described above. Therefore, the signal can be recorded at a high density, and it is possible to reduce the crosstalk and the jitter of the signal. In particular, the optical disk stamper, which is obtained by using the RIE treatment as described above, is highly reliable for the following reason. Shallow depressions are formed at portions of the photoresist layer irradiated with the low intensity laser beam, as on the master disk 1 for the optical disk subjected to the cutting in accordance with the master disk exposure method of Embodiment 1-3. However, the photoresist layer functions as the mask as far as the photoresist layer remains at the portions. Accordingly, it is possible to avoid the etching for the portions during the RIE treatment. As a result, the pit pattern, which corresponds to only the resist pattern exposed with the high intensity laser beam, can be formed on the master disk. Therefore, it is possible to avoid the occurrence of any inconvenience which would be otherwise caused by the formation of the depressions. It is possible to widen the margin when the photoresist layer is exposed.

The optical disk substrate of the present invention is replicated by applying the replication technique by using the optical disk stamper as a template. The optical disk substrate can be used to produce a variety of optical disks including, for example, CD-ROM, CD-R, DVD, DVD-RW, DVD-R, and MO. When the optical disk as described above is used, then the signal can be recorded at a high density, and it is possible to reduce the crosstalk and the jitter of the signal. In particular, as shown in FIG. 7, a high linear recording density can be possessed by the optical disk having the substrate which is formed with the pit having the width longer than the length and which is manufactured by using the master disk formed with the pit (exposure mark) having the width longer than the length. Therefore, it is possible to improve the storage capacity of the optical disk.

Embodiments of the present invention have been explained as exemplified by the specified exposure apparatus for the master disk for the optical disk, the exposure method for the master disk for the optical disk, the optical disk stamper, and the optical disk substrate. However, the gist or the feature of the present invention is not limited thereto. It is a matter of course that the present invention is also applicable to the substrate, the stamper, the exposure method, and the exposure apparatus for the information-recording medium based on any other shape and any other system.

According to the present invention, the high intensity laser beam having the laser intensity not less than the sensitivity of the photosensitive layer and the low intensity laser beam having the laser intensity not more than the sensitivity of the photosensitive layer are radiated onto the different areas of the photosensitive layer. Accordingly, it is possible to solve the problem of the overlap which would be otherwise caused around the portion irradiated with the high intensity laser beam, and it is possible to form the desired pit pattern irrelevant to the pit length and the radiation pattern of the high intensity laser beam. In particular, it is possible to reduce the dispersion of the pit shape and the pit size including, for example, the pit length and the pit width. Therefore, it is possible to provide the information-recording medium in which the jitter and the crosstalk are small even when the high density recording is performed by narrowing the track pitch.

In particular, in the master disk exposure method of the present invention, the sizes of the mark and the pit to be formed by the development are determined irrelevant to whether or not any pit is disposed adjacently in the track direction or in the direction perpendicular thereto. Therefore, even when the track pitch is narrowed, then it is possible to suppress the fluctuation of the pit size and the pit shape, and it is possible to reduce the crosstalk and the jitter on the high recording density information-recording medium. Even when the present invention is applied to the master disk exposure apparatus based on the CLV system, it is unnecessary to correctly predict the exposure signal for the adjacent track to be exposed after one round. Therefore, it is unnecessary to provide any complicated signal-correcting circuit, it is possible to simplify the arrangement of the master disk exposure apparatus, and it is possible to perform the correct cutting of the pit array. Further, in the master disk exposure method of the present invention, the laser beam, which has the laser intensity less than the sensitivity of the photoresist layer, is radiated onto the both sides in the disk radial direction of the area in which the shortest mark is formed. Therefore, the width of the shortest mark can be made to be equivalent to those of the marks having the other lengths. Further, it is possible to form the mark having the width longer than the mark length. Therefore, when the master disk exposure method of the present invention is used, it is possible to realize the super high density recording on the information-recording medium.

The optical disk stamper of the present invention is formed with the master disk in which the fluctuation of the pit size and the pit shape is extremely suppressed. Therefore, it is possible to replicate the substrate for the information-recording medium such as the optical disk on which the signal can be recorded at a high density, and the crosstalk and the jitter of the signal can be reduced.

The substrate for the information-recording medium of the present invention is formed by using the stamper of the present invention as the template. Therefore, it is possible to provide the information-recording medium on which the signal can be recorded at a high density, and it is possible to reduce the crosstalk and the jitter of the signal. Further, the prepit array includes the prepit in which the width in the direction perpendicular to the arrangement direction of the prepit array is larger than the length in the arrangement direction of the prepit array. Therefore, it is possible to improve the linear recording density of the information-recording medium such as the optical disk, and it is possible to improve the recording capacity of the information-recording medium.

When the master disk exposure apparatus of the present invention is used, then the fluctuation of the pit size and the pit shape, which would be otherwise caused by the occurrence of the overlap, can be suppressed, and it is possible to form the master disk for the high recording density information-recording medium such as the optical disk in which the jitter and the crosstalk are reduced. In particular, when the master disk exposure apparatus of the present invention is used, the single optical modulator can be employed to perform the modulation of the intensity of the laser beam in accordance with the exposure signal, simultaneously with which the laser beam can be separated into the two beams. Therefore, it is unnecessary to provide a plurality of modulators. The master disk exposure apparatus can be produced at low cost in a compact form. Even when the present invention is applied to the master disk exposure apparatus based on the CLV system, it is unnecessary to correctly predict the exposure signal for the adjacent track to be exposed after one round. Therefore, it is unnecessary to provide any complicated signal-correcting circuit. It is possible to simplify the arrangement of the master disk exposure apparatus, and it is possible to perform the correct cutting of the pit array.

1. A master disk exposure method for exposing with a certain pattern a master disk which is used for making a disk-shaped information-recording medium and on which a photoresist layer is formed, the master disk exposure method comprising:
irradiating a predetermined area of a photoresist with a first laser beam which has an intensity not less than a sensitivity of the photoresist layer and which has a predetermined phase; and
irradiating an area of the photoresist different from the predetermined area with a second laser beam which has an intensity less than the sensitivity of the photoresist layer and which has a phase opposite to the predetermined phase.

2. The master disk exposure method according to claim 1, further comprising irradiating both sides in a disk radial direction of an area on which a shortest mark of the certain pattern is formed, with a third laser beam which has an intensity less than the sensitivity of the photoresist layer.

3. The master disk exposure method according to claim 1, wherein the first laser beam is radiated onto a track center of the master disk, and the second laser beam is radiated onto both sides of the track center.

4. The master disk exposure method according to claim 3, wherein a track pitch is identical with a spacing distance between radiation positions of the second laser beam radiated onto the both sides of the track center.

5. The master disk exposure method according to claim 1, wherein the second laser beam has a same intensity as that of a third laser beam.

6. The master disk exposure method according to claim 1, wherein the first laser beam has a same phase as that of a third laser beam in relation to a shortest mark.

7. A method for manufacturing a master disk, comprising:
exposing the master disk in accordance with the master disk exposure method as defined in claim 1;
developing the photoresist layer after the exposure to form a resist pattern corresponding to the certain exposure pattern on the surface of the master disk; and
performing reactive ion etching by using the resist pattern as a mask to manufacture the master disk.

8. An optical disk stamper which is replicated from the master disk obtained in accordance with the method for manufacturing the master disk as defined in claim 7.

9. A substrate for an information-recording disk which is formed by using the stamper as defined in claim 8 as a template, wherein the substrate includes a prepit in which a length in a direction perpendicular to a track direction is longer than a length in the track direction.

10. A master disk exposure apparatus for forming a certain exposure pattern on a photoresist layer on a master disk for an information-recording medium by radiating a laser beam onto the master disk, the master disk exposure apparatus comprising:
a laser light source;
an optical modulator which intensity-modulates the laser beam emitted from the laser light source in accordance with an exposure signal and which separates the laser beam into two beams having mutually opposite phases;
a beam divider which divides one beam of the two beams;
a collecting radiation position adjuster which adjusts radiation positions so that the one beam divided by the beam divider is radiated onto both sides of a radiation position of the other beam of the two beams on the photoresist layer; and
an intensity adjuster which adjusts an intensity of the one beam to be lower than a sensitivity of the photoresist layer.

11. The master disk exposure apparatus according to claim 10, wherein the optical modulator is an acousto-optical modulator which separates the laser beam into 0th order diffracted light and 1st order diffracted light.

12. The master disk exposure apparatus according to claim 10, further comprising a half wave plate through which the one beam passes, and a polarizing beam splitter which combines the one beam and the other beam.

13. The master disk exposure apparatus according to claim 10, wherein the intensity adjuster adjusts the intensity of the one beam to be less than ½ of the sensitivity of the photoresist layer.

14. The master disk exposure apparatus according to claim 10, wherein the beam divider is a diffraction grating.

15. The master disk exposure apparatus according to claim 10, wherein the beam divider is a phase shift plate.

16. A master disk exposure apparatus for forming a certain exposure pattern on a photoresist layer on a master disk for an information-recording medium by radiating a laser beam onto the master disk, the master disk exposure apparatus comprising:
a laser light source;
a first beam divider which separates the laser beam radiated from the laser light source into first and second beams;
a first optical modulator which intensity-modulates the first beam divided by the first beam divider in accordance with an exposure signal;
a second optical modulator which intensity-modulates the second beam divided by the first beam divider in accordance with a signal having a phase opposite to that of the exposure signal;
a second beam divider which divides the second beam intensity-modulated by the second optical modulator;
a collecting radiation position adjuster which adjusts radiation positions so that the second beam divided by the second beam divider is radiated onto both sides of a radiation position of the first beam on the photoresist layer; and
an intensity adjuster which adjusts an intensity of the second beam to be lower than a sensitivity of the photoresist layer.

17. The master disk exposure apparatus according to claim 16, wherein the second optical modulator includes a signal-cutting circuit.

18. The master disk exposure apparatus according to claim 16, wherein the second beam divider is a diffraction grating which separates the laser beam into +1st order diffracted light and −1st order diffracted light.

19. The master disk exposure apparatus according to claim 16, wherein the second beam divider is an acousto-optical deflector which separates the laser beam into +1st order diffracted light and −1st order diffracted light.

20. The master disk exposure apparatus according to claim 16, further comprising a half wave plate through which the first beam passes, and a polarizing beam splitter which combines the first beam and the second beam.

21. The master disk exposure apparatus according to claim 16, wherein the intensity adjuster adjusts the intensity of the second beam to be less than ½ of the sensitivity of the photoresist layer.
